(19) United States
(12) Patent Application Publication
(10) Pub. No.: US 2015/0178788 A1
(43) Pub. Date: Jun. 25, 2015

(54) MEDIA SERVICE RECOMMENDATION AND SELECTION

(71) Applicant: Luma, LLC, Minneapolis, MN (US)

(72) Inventors: Aaron Weber, Orono, MN (US); Chris Miller, Saint Louis Park, MN (US)

(73) Assignee: Luma, LLC, Minneapolis, MN (US)

(21) Appl. No.: 14/607,704

(22) Filed: Jan. 28, 2015

Related U.S. Application Data
(63) Continuation-in-part of application No. 14/483,452, filed on Sep. 11, 2014.
Application No. 14/483,452 is a continuation-in-part of application No. 13/792,279, filed on Mar. 11, 2013.
Application No. 13/792,279 is a continuation-in-part of application No. 12/892,274, filed on Sep. 28, 2010, now Pat. No. 8,401,983.
Application No. 12/892,274 is a continuation-in-part of application No. 12/892,320, filed on Sep. 28, 2010, now Pat. No. 8,825,574.
Application No. 12/892,320 is a continuation-in-part of application No. 12/903,830, filed on Oct. 13, 2010.
(60) Provisional application No. 61/876,653, filed on Sep. 11, 2013.
(60) Provisional application No. 61/251,191, filed on Oct. 13, 2009.

(51) Int. Cl. G06Q 30/02; H04L 29/06

(52) U.S. Cl. CPC G06Q 30/0269; H04L 65/60

(57) ABSTRACT

A method of operating a recommendation system comprises presenting a plurality of subscribed streaming media item recommendations to a user based on known user preferences. The subscribed streaming media item recommendations include streaming media items from at least one subscribed streaming media service, from a plurality of available streaming media services. An advertisement is presented for an unsubscribed streaming media service to which the user does not subscribe, from the plurality of available streaming media services. The advertisement comprises a plurality of streaming media items available from the unsubscribed streaming media service, based on known user preferences and presented in a format substantially similar to a format of the presented subscribed streaming media item recommendations.

### CROSS-REFERENCE TO RELATED APPLICATIONS

This application claims priority to pending U.S. patent application Ser. No. 14/483,452, filed Sep. 11, 2014. That application further claims priority to provisional application 61/876,653, filed Sep. 11, 2013, titled “Media Recommendation”, and to U.S. patent application Ser. No. 13/792,279 (Attorney Docket 102.002US02), filed on Mar. 11, 2013, which is a continuation-in-part of U.S. patent application Ser. No. 12/892,274 (Attorney Docket 102.002US01), filed on Sep. 28, 2010, now issued as U.S. Pat. No. 8,401,983, and which is further a continuation-in-part of U.S. patent application Ser. No. 12/892,320 (Attorney Docket 102.003US1), filed on Sep. 28, 2010, and which is further continuation-in-part of U.S. patent application Ser. No. 12/903,830 (Attorney docket 102.001US01), filed on Oct. 13, 2010, which in turn claims the priority of U.S. provisional application No. 61/251,191 (Attorney docket 102.001PRV), filed on Oct. 13, 2009. All of the U.S. priority applications are hereby incorporated by reference.

### FIELD

The invention relates generally to media item recommendation, and more specifically to media service and item recommendation and selection.

### BACKGROUND

The rapid growth of the Internet and the proliferation of inexpensive digital media devices have led to significant changes in the way media is bought and sold. Online vendors provide music, movies, and other media for sale on websites such as Amazon, for rent on websites such as Netflix, and available for person-to-person sale on websites such as eBay. The media is often distributed in a variety of formats, such as a movie available for purchase or rental on a DVD or Blu-Ray disc, for purchase and download, or for streaming delivery to a computer, media appliance, or mobile device.

Internet companies that provide media such as music, books, and movies derive profit from their sales, and it is in their best interest to sell customers multiple items or subscriptions to provide an ongoing stream of profits. Netflix, for example, provides a subscription service to customers enabling them to rent or stream movies, and profits as long as subscribers continue to find enough new movies to watch to remain a subscriber. Pandora provides streaming audio in a customized music station format based on a customer's music preferences, deriving profit from either subscriptions or from advertising placed in limited free services. Amazon derives much of its profits from sale of physical media, and increases its profit from providing a customer with media recommendations similar to items that a customer has already purchased.

Recommendations such as these are typically made by employing a recommendation engine to identify media that is similar to other media in which a customer has shown an interest, such as by purchasing, renting, or rating related media. Pandora, for example, uses an expert's characterization of a song using domain knowledge attributes such as structure, instrumentation, rhythm, and lyrical content to produce domain knowledge data for each song, and provides streaming songs matching identified customer preferences for one or more distinct customized stations based on its domain knowledge-based recommendation engine. Other media providers such as Netflix provide correlation-based recommendations, where user preferences for similar movies over a broad base of users and media are used to find preference correlation between the media and users in the database to recommend media correlated to other media a customer has liked.

Because the number of items purchased or the length of a subscription are related to the value customers receive in continuing to interact with a media provider, it is in the provider's best interest to provide media recommendations that are accurate and well-tailored to its customers, and that appeal to users based on the user's individual preferences.

### SUMMARY

One example embodiment of the invention comprises a method of operating a recommendation system, including presenting a plurality of subscribed streaming media item recommendations to a user based on known user preferences. The subscribed streaming media item recommendations include streaming media items from at least one subscribed streaming media service, from a plurality of available streaming media services. An advertisement is presented for an unsubscribed streaming media service to which the user does not subscribe, from the plurality of available streaming media services. The advertisement comprises a plurality of streaming media items available from the unsubscribed streaming media service, based on known user preferences and presented in a format substantially similar to a format of the presented subscribed streaming media item recommendations.

In a further example, the advertisement's streaming media items are presented in an arrangement of media items consistent with an arrangement of the presented plurality of subscribed streaming media items, having a media item size similar to a size of the presented plurality of subscribed streaming media items, and having a presentation of each individual media item consistent with a presentation of the presented plurality of subscribed streaming media items.

In another example, the presented advertisement is user-selectable to initiate one or more of a trial subscription, a subscription, or a purchase from the unsubscribed streaming media service, such that a provider of the media recommendation system is compensated upon such user selection

The details of one or more examples of the invention are set forth in the accompanying drawings and the description below. Other features and advantages will be apparent from the description and drawings, and from the claims.

### BRIEF DESCRIPTION OF THE FIGURES

FIG. 1 shows a media recommendation system including user-specific unsubscribed media item advertisement, consistent with an example embodiment.

FIG. 2 shows a screen image illustrating inline streaming media advertisement, consistent with an example embodiment.

FIG. 3 shows interaction of a media recommendation service featuring inline recommendation advertising with other computerized systems, consistent with an example embodiment.

FIG. 4 is a flowchart of a method of presenting an inline streaming media item advertisement for an unsubscribed streaming media service, consistent with an example embodiment.

FIG. 5 is a computerized media recommendation system comprising an inline recommendation advertising module, consistent with an example embodiment of the invention.

### DETAILED DESCRIPTION

In the following detailed description of example embodiments, reference is made to specific example embodiments by way of drawings and illustrations. These examples are described in sufficient detail to enable those skilled in the art to practice what is described, and serve to illustrate how elements of these examples may be applied to various purposes or embodiments. Other embodiments exist, and logical, mechanical, electrical, and other changes may be made.

Features or limitations of various embodiments described herein, however important to the example embodiments in which they are incorporated, do not limit other embodiments, and any reference to the elements, operation, and application of the examples serve only to define these example embodiments. Features or elements shown in various examples described herein can be combined in ways other than shown in the examples, and any such combinations is explicitly contemplated to be within the scope of the examples presented here. The following detailed description does not, therefore, limit the scope of what is claimed.

Recommendation of media such as books, movies, or music that a customer is likely to enjoy can improve the sales of online merchants such as Amazon, improve the subscription rate and customer duration of rental services such as Netflix, and help the utilization rate of advertising-driven services such as Pandora. Although revenue is derived from providing media in different ways in each of these examples, they all benefit from providing good quality recommendations to customers regarding potential media purchases, rentals, or other media use. Similarly, knowledge of a user's preferences and interests can help target advertising that is relevant to a particular user, such as advertising horror movies only to those who have shown an interest in honor films, targeting country music advertising toward those who prefer country to rap or pop music, and presenting advertising for a new book to those who have shown a preference for similar books.

Media recommendations such as these are typically made by employing a recommendation engine to identify media that is similar to other media in which a customer has shown an interest, such as by purchasing, renting, or rating other similar media. Some websites, such as Netflix, ask a user to rate dozens of movies upon enrollment so that the recommendation engine can provide meaningful results. Other websites such as Amazon rely more upon a customer's purchase history and items viewed during shopping. Pandora differs from these approaches in that a user can rate relatively few pieces of media, and is provided a broad range of potentially similar media based on domain knowledge of the selected media items.

Because the number of items purchased or the length of a subscription are related to the value a customer receives in interacting with a media provider, it is in the provider's best interest to provide media recommendations that are accurate and well-suited to its customers. Poor recommendations may result in a user abandoning a service or merchant for another, while good recommendations will likely result in additional sales and profit. It is therefore desirable to accurately characterize and predict a user's media preferences to provide the best quality media recommendations possible.

Making accurate recommendations relies in part in having accurate data regarding characteristics of media that may be recommended, so that information regarding a user's preferences can be used to accurately search through media to select items to recommend. For example, a system such as Pandora that relies on domain knowledge of songs to recommend other songs relies on accurate expert characterization of various attributes of each song in its library to enable songs to be found and recommended based on the characterized attributes. Other recommendation systems rely more heavily on correlation, such as determining what other items a user who likes a certain movie is most likely to like by mining a database of user ratings or preference information.

Accurate recommendations further rely in part on accurate characterization of an individual user's media preferences. Although the overall or group rating of the quality of a media item such as a movie can provide some indication of how an average user may like a particular media item, customization of recommendations based on the tastes and preferences of individual users provides individual users with more meaningful and consistently high quality recommendations.

Taste profiles for individual users are typically built over time using known user preferences, such as by having a user rate each movie viewed or song heard, and using the gathered preference information to build a database of user preferences that can be used with methods such as media item correlation and domain knowledge of media items to recommend additional media items. But, managing user preference across multiple services or providers can be challenging, and matching a user to a service that fits the user's preferences is often simply based on trial and error, word of mouth, or other methods that do not take user preferences into account.

Some embodiments of the invention therefore employ known user preferences, such as preferences known by a third-party recommendation service or by a streaming media provider, to recommend one or more items from one or more services to which the user is not subscribed. In one such example, a recommendation service presents media item recommendations from one or more subscribed media services to a user based on the user's known preferences, such as from the user's rating various media items. The service further selects and presents an advertisement for an unsubscribed streaming media service to which the user does not subscribe, including one or more streaming media items available from the unsubscribed streaming media service, based on known user preferences. In a further example, the media items from the unsubscribed service are presented in a format substantially similar to a format of the presented subscribed streaming media item recommendations, such as by presenting the unsubscribed recommended items in the first row of a listing of recommended items, where other rows include substantially media items from services or providers to which the user is subscribed.

The items recommended from an unsubscribed provider are in some examples presented in various ways that mimic presentation of media items from services to which the user has subscribed (or that are free, or are otherwise selected by the user), such as having a consistent arrangement of the subscribed and unsubscribed streaming media items, presenting unsubscribed media item in a size similar to a size of the subscribed streaming media items, and having a presentation or context of each individual media item consistent with a presentation of the presented plurality of subscribed streaming media items.

The third party recommendation service or other media preference provider in some embodiments presents the advertisement in a way that is user-selectable to initiate a trial subscription, a subscription, or a purchase from the unsubscribed streaming media service, such that a provider of the media recommendation system may be compensated upon such user selection.

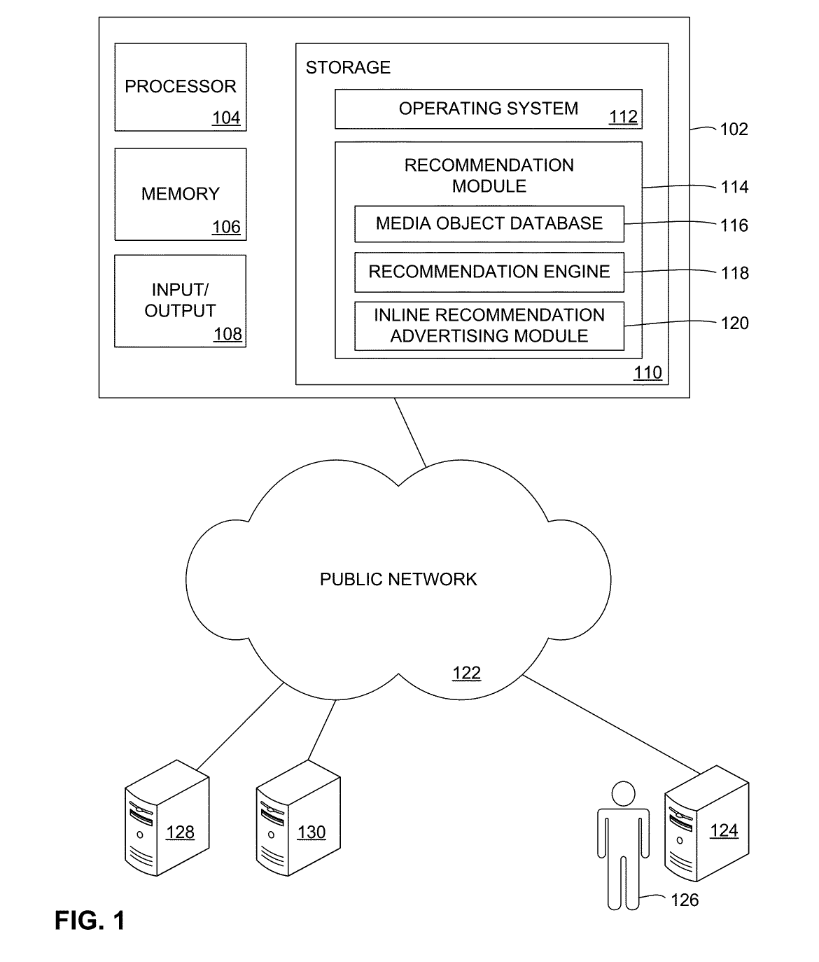

FIG. 1 shows a media recommendation system including user-specific unsubscribed media item advertisement, consistent with an example embodiment. Here, media recommendation system 102 comprises a processor 104, memory 106, input/output elements 108, and storage 110. Storage 110 includes an operating system 112, and a recommendation module 114 that is operable to provide media item recommendations to a user such as user 126. The recommendation module 114 further comprises a media object database 116 operable to store media object information and user preference information for various media objects, such as media objects from various third-party media providers. A recommendation engine 118 is operable to use the stored media preference information for various recommendation system users to provide media recommendations. Inline recommendation advertising module 120 is operable to use known user preference information to generate an advertisement that accompanies a presentation of recommended subscribed media items for the user, such that the advertisement includes one or more media items selected for recommendation to the user and is presented inline with the presentation of recommended subscribed media items.

The media recommendation system 102 is connected to a public network 122, such as the Internet. Public network 122 serves to connect the media recommendation system 102 to remote computer systems, including user computer 124 (associated with user 126). Media recommendation system 102 is further connected to third-party streaming media servers 128 and 130, such that the user may have subscriptions to some third-party media services and not have subscriptions to other third-party media services.

In operation, the media recommendation system's processor 104 executes program instructions loaded from storage 110 into memory 106, such as operating system 112 and recommendation module 114. The recommendation module includes software executable to create media recommendations for user 126 based on the user's known preferences, including recommendations from one or more subscribed media services 128, and to present an advertisement for at least one media item from an unsubscribed media service such as 130 inline with the recommendations for media items from the one or more subscribed services 128.

The media item recommendations generated by recommendation engine 118 are based in some examples upon media preference information derived from user demographic information, correlation between items in which the user has expressed a preference, and characteristics of various media items and characteristics for which the user has shown a preference. The media recommendation system 102 then uses recommendation engine 118 and media object database 116 to generate media recommendations consistent with the user's known preferences. Recommendations are generated and provided to the user using correlation-based recommendations, domain knowledge-based recommendations, demographics, or a combination of such methods.

In a more detailed example, user 126 logs on to a recommendation provider, such as a third-party media item recommendation service 102, a streaming media service, an online merchant, or another such provider. The user submits a request for recommendations, such as for movies, television shows, or other media items, products, or services. The recommendation module 114 uses media object database and recommendation engine to recommend objects meeting the user's query, such as streaming media objects available from server 128 or other servers to which the user has subscribed, including in various embodiments servers which provide free items or which a user has otherwise selected. In preparing the recommended objects for presentation to the user, the recommendation module 114 further uses inline recommendation advertising module to generate recommendations for one or more recommended media items from a streaming media service to which the user has not subscribed, also based on user 126's preferences.

The recommendations from subscribed services 128, such as streaming media items, are presented to the user 126 via user's computer 124 with at least one item from unsubscribed service 130 presented inline with the subscribed item results, as an advertisement. The user is then able to view the recommended unsubscribed media item or items along with the subscribed recommended items, and to consider purchase, trial, or subscription that would enable the user to view the unsubscribed item.

In a further example, the user selects one of the advertised unsubscribed items from the presentation, and is able to subscribe to the service providing the unsubscribed item, buy or rent the unsubscribed item, or initiate a trial subscription to the service providing the unsubscribed item. This includes in a further example compensation provided to the recommendation service 102 for presenting one or more of the advertised items, for the user selecting one of the advertised items, for the user initiating a trial subscription, or for the user making a purchase such as buying a subscription or renting or buying the unsubscribed item.

In another embodiment, the recommendation service 102 selects a streaming media service or other such provider from among a number of unsubscribed providers for inclusion in an inline advertisement based at least in part on the quality of the match between the unsubscribed media items available from the service and the user's known preferences. This increases the chances that a user will select the advertisement, subscribe to the service, and enjoy the recommendation, benefiting all parties involved.

The user benefits from inline advertising of streaming media items in that the advertisements presented to a user include media items in which the user is most likely to have an interest, making the advertisement of greater value to the user. The unsubscribed third party provider is similarly more likely to attract a new user, by presenting items in which the user is more likely to be interested. The media recommendation service also benefits, in that it can provide high quality recommendations from a broader pool of media items, and it may receive increased advertising dollars, compensation for converted subscriptions or sales, and other such revenue.

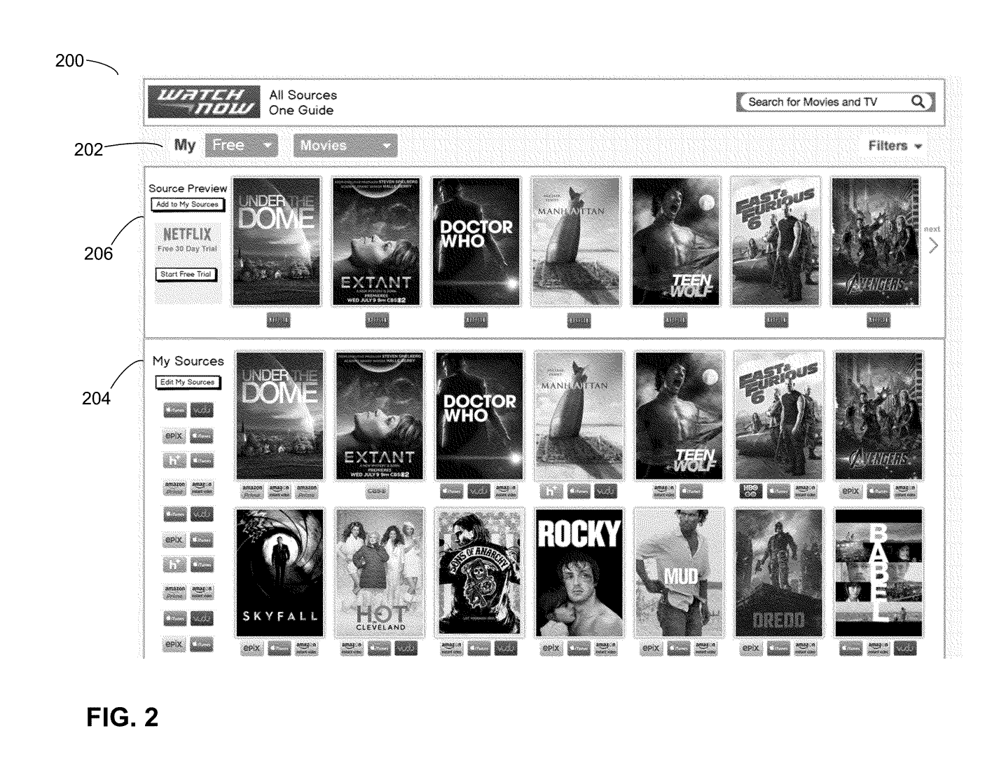

FIG. 2 shows a screen image illustrating inline streaming media advertisement, consistent with an example embodiment. As shown generally at 200, a number of media items are presented as recommended streaming media items for a logged in user. The presented image is displayed, for example, on user 126's computer 124 as a result of the user logging in and initiating a search or query. The image is a web page, served by recommendation server 102 via the Internet public network 122 to the user's computer, but in other examples is presented to a smart phone browser or app, television app, or other computerized device or program.

The example screen image presented here shows at 202 a number of user-selected sources, such as subscribed streaming media services, free streaming media services, pay streaming media services which the user would like included in search results, or other such “subscribed” streaming media services. In this example, the user has selected to view only movies that incur no additional charge to view at 202, with the results presented below.

Streaming media items from the various services that meet the user's search criteria are presented as promotional images with movie presented thereon, with a notation of what services have the presented media item available presented as icons immediately under each media item as shown at 204. For example, the television movie “Extant” is available only on CBS among subscribed sources, which in this case is a free streaming media service the user has included among subscribed services.

At 206, a number of streaming media items available on Netflix, an unsubscribed streaming media service, are also presented to the user. Here, the media items are presented in the same format as the streaming media items presented at 204, including the same promotional image with a name format having a notation that each movie is available on Netflix immediately under the streaming media item. In a further example, the advertisement also shows subscribed services which carry the advertised streaming media items, or selects advertised streaming media items which are not available from a streaming media service to which the user already subscribes.

The advertised streaming media items shown at 206 and the subscribed streaming media items shown at 204 are here presented inline, arranged in the same row format, in the same size, in columns that align, that have similar image size, that have similar configuration of promotional image and source buttons, and that generally have the same arrangement and presentation of individual media items. In other examples, the advertised media items and the subscribed media items will have other characteristics in common, making media items in the advertisement at 206 blend with the presentation of subscribed media items shown at 204.

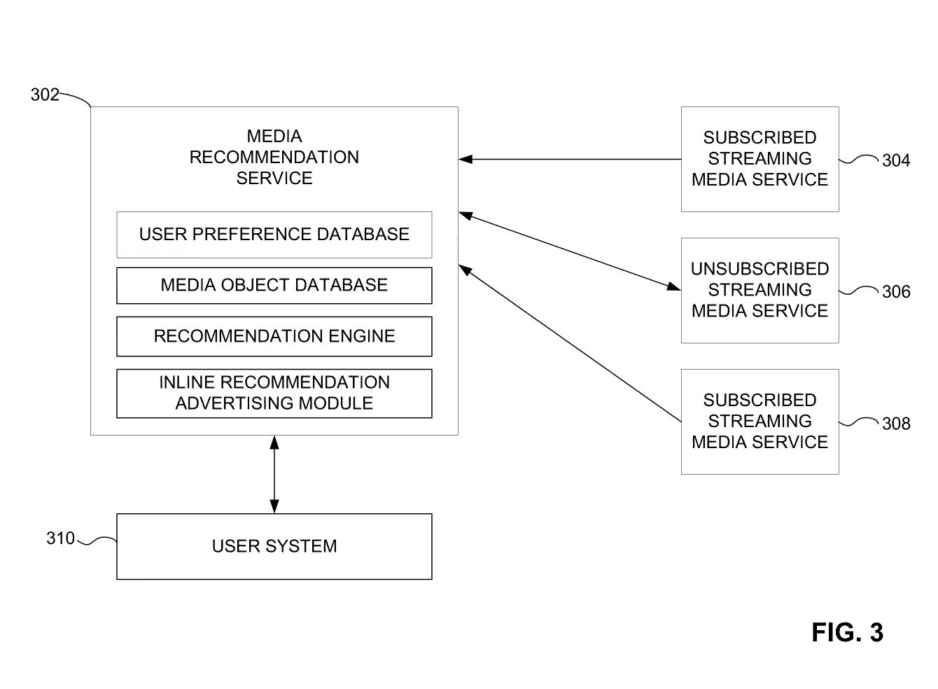

FIG. 3 shows interaction of a media recommendation service featuring inline recommendation advertising with other computerized systems, consistent with an example embodiment. Here, a media recommendation service 302 includes a user preference database including preferences for one or more users of the media recommendation service, such as ratings for selected media items, preferences regarding characteristics of media items, and other such preference information. The recommendation service also includes a media object database, including media items from a variety of streaming media services, such as subscribed media services 304 and 308, and unsubscribed streaming media services such as 306. In some embodiments, one or more users may be subscribed to all or none of the available streaming media services.

A recommendation engine within media recommendation service 302 is operable to use known user preference information from the user preference database to generate media item recommendations for one or more users, who access the media recommendation service through user system 310. User system 310 includes in various embodiments any suitable computerized system, including a personal computer, a tablet, a smartphone, a television, a set top box, or other such system. A user of user system 310 is therefore able to query the media recommendation service 302 for recommendations for streaming media items in the media object database, including streaming media items from subscribed streaming media service 304 and 308. The media recommendation service then returns such recommendations to user system 310, such as via a web page, via a user system app, or through another such mechanism.

The media recommendation service is further operable to present an inline advertisement for unsubscribed streaming media items from an unsubscribed streaming media service 306, such as by searching the media object database in media recommendation service 302 for an unsubscribed streaming media service having unsubscribed media items suitable for recommendation to the user. In a further example, the unsubscribed streaming media service having unsubscribed streaming media items that best fit the requesting user's known media preferences is selected or is given preference over other unsubscribed streaming media services for advertisement. In a further example, only unsubscribed media items from the unsubscribed streaming media service which are not available from subscribed streaming media services are considered in selecting an unsubscribed streaming media service for advertisement, in selecting unsubscribed streaming media items from the unsubscribed streaming media service for recommendation to the user, or both.

If the user selects the inline advertisement for an unsubscribed streaming media item or service, such as by electing to subscribe or start a trial subscription, to rent or purchase a streaming media item, or another such indication of selection, the media recommendation service may initiate a user transaction with the unsubscribed streaming media service to complete the indicated user request. For example, a user may select an unsubscribed streaming media item from an unsubscribed streaming media service, thereby initiating a purchase, trial subscription, or other transaction with unsubscribed streaming media service 306. The user is then redirected to unsubscribed streaming media 306 to complete the transaction, and media recommendation service 302 is compensated as the referrer of the transaction, such as by receiving an advertising fee, a percentage of a purchase, or a fee for users who initiate a trial subscription.

In a further example, the media recommendation service 302 is compensated for presenting the advertisement to a user, such as being paid a fee for showing the advertisement, a fee for the user selecting the advertisement, a fee for the user initiating a trial as a result of the advertisement, and/or a fee for the user making a purchase as a result of the advertisement. In another example, the third party service providers can bid for presentation of advertisements for their media items, such as a provider that will bid relatively high to present “House of Cards” to viewers who loved “The West Wing,” or a studio that is willing to outbid other providers to present an advertisement including “Toy Story 2” to viewers who loved “Toy Story.”

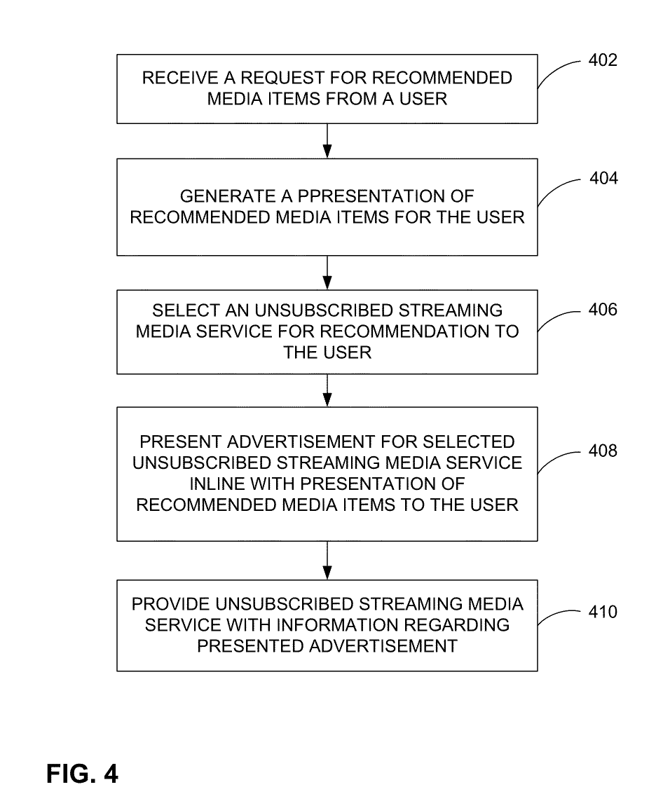

FIG. 4 is a flowchart of a method of presenting an inline streaming media item advertisement for an unsubscribed streaming media service, consistent with an example embodiment. Here, a media recommendation system receives a request for recommended media items from a user at 402. The media recommendation system then generates a presentation of recommended media items for the user at 404, including items from subscribed streaming media sources such as free, selected, or paid streaming media sources. Recommended media items are selected by correlating known user preferences for some media items with media items the user has not seen (correlation) in some examples, while other examples include known user preferences of media item characteristics with characteristics of media items the user has not seen (domain knowledge) or other such preference matching of media items.

The media recommendation system also selects an unsubscribed streaming media service for advertisement to the user at 406, such as by evaluating the match between known preferences of the user and various media items available from the unsubscribed streaming media service that are not already available to the user. In some embodiments, the unsubscribed media items are selected based on the recommendation score or predicted user rating of the selected unsubscribed media items not already available to the user, and in some embodiments the unsubscribed streaming media service is selected based on the recommendation quality or predicted user rating of media items available from the unsubscribed streaming media service that are not already available to the user.

At 408, an advertisement for the selected unsubscribed streaming media service is presented to the user, inline with the presentation of recommended media items. In one example, this comprises presenting the advertised unsubscribed streaming media items in a row above one or more rows of presentation of recommended media items generated at 404.

The media recommendation service then provides the unsubscribed streaming media service with information regarding the presented advertisement at 410, such as presenting a record of the advertisement or presenting a user selection of the advertisement, such as a user clicking to subscribe to the unsubscribed streaming media service, initiate a trial subscription to the unsubscribed streaming media service, make a purchase from the unsubscribed streaming media service, or perform another such transaction with the unsubscribed streaming media service. The information includes in some examples the identity of the recommendation service, such that the unsubscribed streaming media service can compensate the recommendation service presenting the advertisement for the advertisement and/or resulting transactions.

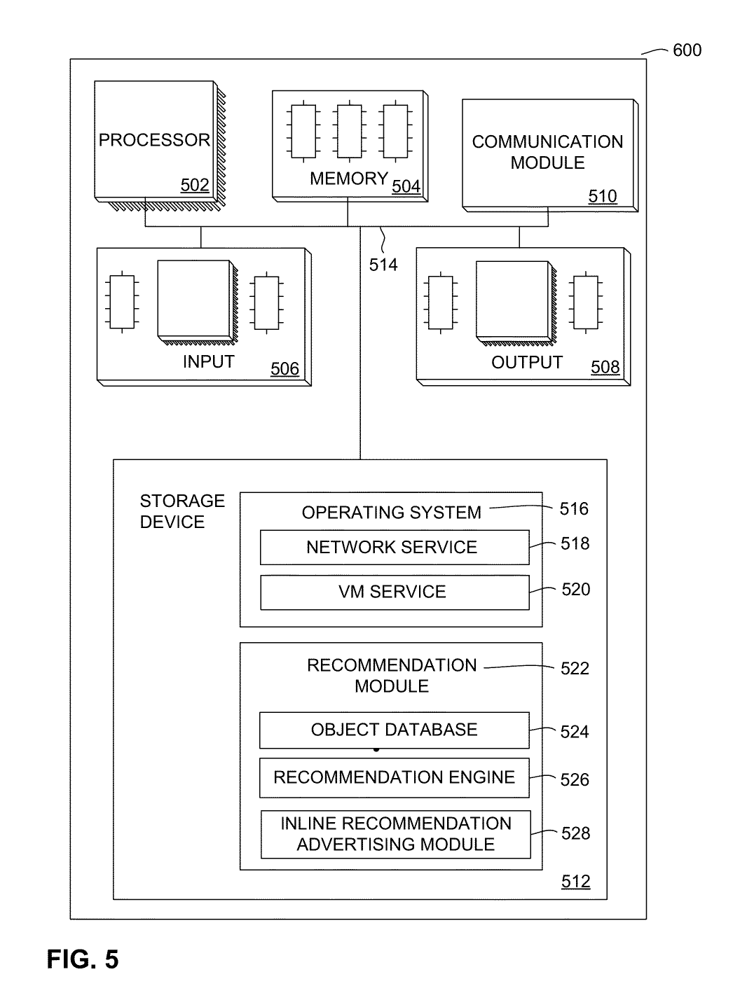

FIG. 5 is a computerized media recommendation system comprising an initial profile creation module, consistent with an example embodiment of the invention. FIG. 5 illustrates only one particular example of computing device 500, and other computing devices 500 may be used in other embodiments. Although computing device 500 is shown as a standalone computing device, computing device 500 may be any component or system that includes one or more processors or another suitable computing environment for executing software instructions in other examples, and need not include all of the elements shown here.

As shown in the specific example of FIG. 5, computing device 500 includes one or more processors 502, memory 504, one or more input devices 606, one or more output devices 508, one or more communication modules 510, and one or more storage devices 512. Computing device 500, in one example, further includes an operating system 516 executable by computing device 500. The operating system includes in various examples services such as a network service 518 and a virtual machine service 520 such as a virtual server. One or more applications, such as recommendation module 522 are also stored on storage device 512, and are executable by computing device 500.

Each of components 502, 504, 506, 508, 510, and 512 may be interconnected (physically, communicatively, and/or operatively) for inter-component communications, such as via one or more communications channels 514. In some examples, communication channels 514 include a system bus, network connection, inter-processor communication network, or any other channel for communicating data. Applications such as recommendation module 522 and operating system 516 may also communicate information with one another as well as with other components in computing device 500.

Processors 502, in one example, are configured to implement functionality and/or process instructions for execution within computing device 500. For example, processors 502 may be capable of processing instructions stored in storage device 512 or memory 6504. Examples of processors 502 include any one or more of a microprocessor, a controller, a digital signal processor (DSP), an application specific integrated circuit (ASIC), a field-programmable gate array (FPGA), or similar discrete or integrated logic circuitry.

One or more storage devices 512 may be configured to store information within computing device 500 during operation. Storage device 512, in some examples, is known as a computer-readable storage medium. In some examples, storage device 512 comprises temporary memory, meaning that a primary purpose of storage device 512 is not long-term storage. Storage device 512 in some examples is a volatile memory, meaning that storage device 512 does not maintain stored contents when computing device 500 is turned off. In other examples, data is loaded from storage device 512 into memory 504 during operation. Examples of volatile memories include random access memories (RAM), dynamic random access memories (DRAM), static random access memories (SRAM), and other forms of volatile memories known in the art. In some examples, storage device 512 is used to store program instructions for execution by processors 502. Storage device 512 and memory 504, in various examples, are used by software or applications running on computing device 500 such as recommendation module 522 to temporarily store information during program execution.

Storage device 512, in some examples, includes one or more computer-readable storage media that may be configured to store larger amounts of information than volatile memory. Storage device 512 may further be configured for long-term storage of information. In some examples, storage devices 512 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 500, in some examples, also includes one or more communication modules 510. Computing device 500 in one example uses communication module 510 to communicate with external devices via one or more networks, such as one or more wireless networks. Communication module 510 may be a network interface card, such as an Ethernet card, an optical transceiver, a radio frequency transceiver, or any other type of device that can send and/or receive information. Other examples of such network interfaces include Bluetooth, 3G or 4G, WiFi radios, and Near-Field Communications (NFC), and Universal Serial Bus (USB). In some examples, computing device 500 uses communication module 510 to wirelessly communicate with an external device such as via public network 122 of FIG. 1.

Computing device 500 also includes in one example one or more input devices 506. Input device 506, in some examples, is configured to receive input from a user through tactile, audio, or video input. Examples of input device 506 include a touchscreen display, a mouse, a keyboard, a voice responsive system, video camera, microphone or any other type of device for detecting input from a user.

One or more output devices 508 may also be included in computing device 500. Output device 508, in some examples, is configured to provide output to a user using tactile, audio, or video stimuli. Output device 508, in one example, includes a display, a sound card, a video graphics adapter card, or any other type of device for converting a signal into an appropriate form understandable to humans or machines. Additional examples of output device 508 include a speaker, a light-emitting diode (LED) display, a liquid crystal display (LCD), or any other type of device that can generate output to a user.

Computing device 500 may include operating system 516. Operating system 516, in some examples, controls the operation of components of computing device 500, and provides an interface from various applications such as recommendation module 522 to components of computing device 500. For example, operating system 516, in one example, facilitates the communication of various applications such as recommendation module 522 with processors 502, communication unit 510, storage device 512, input device 506, and output device 508. Applications such as recommendation module 522 may include program instructions and/or data that are executable by computing device 500. As one example, recommendation module 522 and its object database 524, recommendation engine 526, and inline recommendation advertising module 528 may include instructions that cause computing device 500 to perform one or more of the operations and actions described in the examples presented herein.

Although specific embodiments have been illustrated and described herein, any arrangement that achieve the same purpose, structure, or function may be substituted for the specific embodiments shown. This application is intended to cover any adaptations or variations of the example embodiments of the invention described herein. These and other embodiments are within the scope of the following claims and their equivalents.

1. A method of advertising a streaming media service in a media recommendation system, comprising:
presenting a plurality of subscribed streaming media item recommendations to a user based on known user preferences, the subscribed streaming media item recommendations comprising streaming media items from at least one subscribed streaming media service from a plurality of available streaming media services; and
presenting an advertisement for an unsubscribed streaming media service to which the user does not subscribe from the plurality of available streaming media services, the advertisement comprising a plurality of streaming media items available from the unsubscribed streaming media service based on known user preferences and presented in a format substantially similar to a format of the presented subscribed streaming media item recommendations.

2. The method of advertising a streaming media service in a media recommendation system of claim 1, wherein the advertisement's streaming media items are presented in an arrangement of media items consistent with an arrangement of the presented plurality of subscribed streaming media items, having a media item size similar to a size of the presented plurality of subscribed streaming media items, and having a presentation of each individual media item consistent with a presentation of the presented plurality of subscribed streaming media items.

3. The method of advertising a streaming media service in a media recommendation system of claim 1, wherein presenting a plurality of subscribed streaming media item recommendations to a user based on known user preferences comprises using at least one of domain knowledge and correlation between media items to select media items for recommendation.

4. The method of advertising a streaming media service in a media recommendation system of claim 1, wherein the subscribed streaming media item recommendations comprise streaming media items from a plurality of subscribed streaming media services.

5. The method of advertising a streaming media service in a media recommendation system of claim 1, wherein the unsubscribed streaming media service is selected from among two or more unsubscribed streaming media services based on quality of a match between the unsubscribed media items available from the unsubscribed streaming media service and the user's known preferences.

6. The method of advertising a streaming media service in a media recommendation system of claim 1, wherein the known user preferences comprise user ratings of one or more streaming media items.

7. The method of advertising a streaming media service in a media recommendation system of claim 1, wherein the presented advertisement is user-selectable to initiate one or more of a trial subscription, a subscription, or a purchase from the unsubscribed streaming media service.

8. The method of advertising a streaming media service in a media recommendation system of claim 1, wherein a provider of the media recommendation system is compensated by the unsubscribed streaming media service for at least one of trials, subscriptions, or purchases made via the advertisement.

9. The method of advertising a streaming media service in a media recommendation system of claim 1, wherein a provider of the media recommendation system is compensated by the unsubscribed streaming media service by the unsubscribed streaming media service bidding to present an advertisement including one or more specific media items to users based on known user preference for media items similar to the one more specific media items.

10. The method of advertising a streaming media service in a media recommendation system of claim 1, wherein the plurality of streaming media items available from the unsubscribed streaming media service presented to user are individually selectable for at least one of trial, purchase, or subscription.

11. A media recommendation system, comprising:
a processor; and
a user profile module comprising instructions executable on the processor that are operable when executed to:
present a plurality of subscribed streaming media item recommendations to a user based on known user preferences, the subscribed streaming media item recommendations comprising streaming media items from at least one subscribed streaming media service from a plurality of available streaming media services; and
present an advertisement for an unsubscribed streaming media service to which the user does not subscribe from the plurality of available streaming media services, the advertisement comprising a plurality of streaming media items available from the unsubscribed streaming media service based on known user preferences and presented in a format substantially similar to a format of the presented subscribed streaming media item recommendations.

12. The method of advertising a streaming media service in a media recommendation system of claim 11, wherein the advertisement's streaming media items are presented in an arrangement of media items consistent with an arrangement of the presented plurality of subscribed streaming media items, having a media item size similar to a size of the presented plurality of subscribed streaming media items, and having a presentation of each individual media item consistent with a presentation of the presented plurality of subscribed streaming media items.

13. The method of advertising a streaming media service in a media recommendation system of claim 11, wherein presenting a plurality of subscribed streaming media item recommendations to a user based on known user preferences comprises using at least one of domain knowledge and correlation between media items to select media items for recommendation.

14. The method of advertising a streaming media service in a media recommendation system of claim 11, wherein the streaming media items comprise at least one of television shows and movies.

15. The method of advertising a streaming media service in a media recommendation system of claim 11, wherein the known user preferences comprise user ratings of one or more streaming media items.

16. The method of advertising a streaming media service in a media recommendation system of claim 11, wherein the presented advertisement is user-selectable to initiate one or more of a trial subscription, a subscription, or a purchase from the unsubscribed streaming media service.

17. The method of advertising a streaming media service in a media recommendation system of claim 11, wherein a provider of the media recommendation system is compensated by the unsubscribed streaming media service for at least one of trials, subscriptions, or purchases made via the advertisement.

18. The method of advertising a streaming media service in a media recommendation system of claim 11, wherein the plurality of streaming media items available from the unsubscribed streaming media service presented to user are individually selectable for at least one of trial, purchase, or subscription.

19. A machine-readable medium with instructions stored thereon, the instructions when executed operable to cause a computerized system to:
present a plurality of subscribed streaming media item recommendations to a user based on known user preferences, the subscribed streaming media item recommendations comprising streaming media items from at least one subscribed streaming media service from a plurality of available streaming media services; and
present an advertisement for an unsubscribed streaming media service to which the user does not subscribe from the plurality of available streaming media services, the advertisement comprising a plurality of streaming media items available from the unsubscribed streaming media service based on known user preferences and presented in a format substantially similar to a format of the presented subscribed streaming media item recommendations.

20. The machine-readable medium of claim 19, wherein the presented advertisement is user-selectable to initiate one or more of a trial subscription, a subscription, or a purchase from the unsubscribed streaming media service, such that a provider of the media recommendation system is compensated upon such user selection.
